(19) United States
(12) Patent Application Publication
(10) Pub. No.: US 2026/0330740 A1
(43) Pub. Date: Oct. 22, 2026

(54) METHOD AND ELECTRONIC DEVICE OF ANIMATION RENDERING AND COMPUTER-READABLE STORAGE MEDIUM

(71) Applicant: MediaTek Singapore Pte. Ltd., Singapore (SG)

(72) Inventors: Caigao TANG, Chengdu (CN); Jianwu GAO, Chengdu (CN); Wenxiang ZHONG, Chengdu (CN); Peng LI, Chengdu (CN); Qixuan JIANG, Chengdu (CN); Yu CHEN, Chengdu (CN)

(21) Appl. No.: 19/549,330

(22) Filed: Feb. 25, 2026

(30) Foreign Application Priority Data
Apr. 22, 2025 (CN) 202510514605.0

(51) Int. Cl. G06T 13/80; G06F 3/04883

(52) U.S. Cl. CPC G06T 13/80; G06F 3/04883

(57) ABSTRACT

A method of animation rendering is provided. The method includes: obtaining a user-input event, and recognizing a type of a target page that generated the user-input event to obtain a page type; determining target computing power based on the page type; dispatching the target computing power to generate an animation effect on the target page corresponding to the user-input event. An electronic device is provided. The electronic device includes a memory and a processor. The processor is coupled to the memory and configured to execute program instructions stored in the memory to carry out the method of the animation rendering. A computer-readable storage medium is provided. The computer-readable storage medium has program instructions stored thereon and configured to carry out the method of the animation rendering when the program instructions are run by a processor. Therefore, this enables to maintain the stability of the display effect.

### CROSS REFERENCE TO RELATED APPLICATIONS

This Application claims priority of China Patent Application No. 202510514605.0, filed on Apr. 22, 2025, the entirety of which is incorporated by reference herein.

### TECHNICAL FIELD

The present disclosure relates to animation rendering, and in particular it relates to an animation rendering method, an electronic device, and a storage medium.

### BACKGROUND

Electronic devices, such as cell phones and tablet computers, generally have a display screen and they can display certain images on this screen. When the screen on which something is to be displayed is a different one, the electronic device generally uses a different rendering strategy to display it. This is done in order to improve the display effect of the screen and thus to improve user experience.

When choosing a rendering strategy, the electronic device needs to balance the display effect with power consumption. Generally, in order to achieve a better display effect, the power consumption of the electronic device will be higher.

Therefore, how to produce a better display effect while reducing the power consumption of electronic devices has become an urgent problem.

### BRIEF SUMMARY

The present disclosure provides at least one animation rendering method and an electronic device, and a computer-readable storage medium to at least stabilize the display effect while reducing power consumption of the electronic device.

The present disclosure provides a method of animation rendering in the first aspect. The method includes: obtaining a user-input event, and recognizing a type of a target page that generated the user-input event to obtain a page type; determining target computing power based on the page type; dispatching the target computing power to generate an animation effect on the target page corresponding to the user-input event.

The present disclosure provides an electronic device in the second aspect. The electronic device includes a memory and a processor. The processor is coupled to the memory and configured to execute program instructions stored in the memory to carry out the method of the animation rendering in the first aspect described above.

The present disclosure provides a computer-readable storage medium. The computer-readable storage medium has program instructions stored thereon and configured to carry out the method of the animation rendering in the first aspect when the program instructions are run by a processor.

In the above-described embodiment, according to the page type of the target page on which the user-input event occurs, a corresponding target computing power is determined and dispatched to generate the animation effect corresponding to the user-input event on the target page. Since the dispatched target computing power corresponds to the page type, different target computing power can be dispatched for different page types, allowing adaptation to the different page types through corresponding computing power allocation. Therefore, this enables to maintain the stability of the display effect, and not result in the waste of computing power, thereby reducing the power consumption of the electronic device.

It should be understood that the above general description and the detailed description that follows are exemplary and explanatory only and are not intended to limit the present disclosure.

### BRIEF DESCRIPTION OF THE DRAWINGS

The accompanying drawings herein are incorporated into and form a part of the specification, which illustrate embodiments consistent with the present disclosure and are used in conjunction with the specification to illustrate the technical solutions of the present disclosure.

FIG. 1 is a flow chart of an embodiment of an animation rendering method of the present disclosure.

FIG. 2 is a schematic diagram of an interactive process within an animation rendering system of an embodiment of the present disclosure.

FIG. 3 is a schematic diagram of a module of an electronic device of an embodiment of the present disclosure.

FIG. 4 is a schematic diagram of a module of a computer-readable storage medium of an embodiment of the present disclosure.

### DETAILED DESCRIPTION

The embodiments of the present disclosure are described in detail below in conjunction with the accompanying drawings of the specification.

In the following description, specific details such as particular system structures, interfaces, techniques, and the like are presented for purposes of illustration and not for purposes of limitation, in order to provide a thorough understanding of the present disclosure.

The term “and/or” in the present disclosure is merely a description of the association relationship of the associated objects, indicating that there can be three kinds of relationships, e.g., A and/or B, which can be expressed as: the existence of A alone, the existence of A and B at the same time, and the existence of B alone. In addition, the character “/” in the present disclosure generally indicates that the associated objects before and after are in an “or” relationship. Further, the term “more” herein indicates two or more than two. Furthermore, the term “at least one” herein denotes any one of the plurality or any combination of at least two of the plurality. For example, including at least one of A, B, and C, and may denote including any one or more elements selected from a set consisting of A, B, and C.

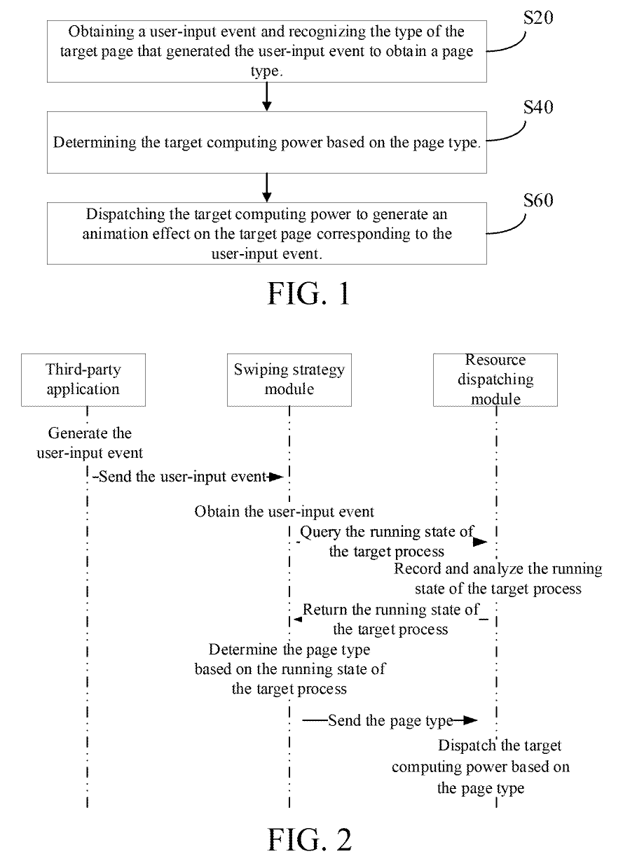

Referring to FIG. 1, FIG. 1 is a flow chart of an embodiment of an animation rendering method of the present disclosure. The animation rendering method includes:

Step S20: Obtaining a user-input event and recognizing the type of the target page that generated the user-input event to obtain a page type.

Step S40: Determining the target computing power based on the page type.

Step S60: Dispatching the target computing power to generate an animation effect on the target page corresponding to the user-input event.

The animation rendering method of the present disclosure may be applied to an electronic device having a display screen, such as a cell phone, a tablet computer, a desktop computer, a laptop, and the like. The user-input event includes a swipe instruction issued by the user in response to a page currently displayed on the screen. For example, the user may swipe on the touch screen via a medium such as a finger, a stylus, etc. And for example, the user may trigger the swipe instruction by swiping the scroll wheel with a mouse, dragging the page, etc. The present disclosure does not impose any limitations on the triggering method of the user-input event.

Taking a user's swiping operation on a cell phone screen as an example, when the user's finger swipes on the screen, a swiping instruction is triggered, i.e., at this time, the user-input event is to swipe the currently displayed page. For example, swipe up and down on the WeChat Moments page to browse more content. After the user triggers the swiping instruction, the electronic device receives the swiping instruction and performs type recognition on the target page of the swiping instruction to obtain the page type. For example, perform type recognition on the WeChat Moments page to obtain the page type of the WeChat Moments page. The target computing power is determined based on the page type and is required for rendering the recognized page type, i.e., when using the target computing power to render the corresponding type of page, it is just enough to ensure that the frame rate of the screen displayed on the screen is stable. After determining the target computing power, the target computing power can be dispatched to render the target page to generate an animation effect corresponding to the user-input event, e.g., the user's swiping command, the animation effect including scrolling of the page content.

In the present disclosure, page types include HWUI, Webview, GIthread, Flutter, etc.

In the above-described embodiment, a corresponding target computing power is determined based on the page type of the target page on which the user-input event occurs so as to dispatch the target computing power to generate an animation effect corresponding to the user-input event on the target page. As the dispatched target computing power corresponds to the page type and different target computing power can be dispatched for different page types, it can adapt to different page types by dispatching different target computing power. Therefore, the stability of the display effect can be maintained, and the computing power will be efficiently utilized, thereby reducing the power consumption of the electronic device.

In some embodiments, obtaining a user-input event and recognizing the type of the target page that generated the user-input event to obtain a page type includes:

Step S21: Determining a target process for processing the user-input event.

Step S22: identifying the page type of the target page for the user-input event based on the running state of the target process.

The target process for processing the user-input event is the process for providing the target page of the user-input event. For example, if the target page of the user's swiping instruction is a Moments page, the target process for processing the swiping instruction is the process for rendering the content of the Moments page and its scrolling animation. The running state of the target process includes the engine characteristic state of the rendering engine that renders the target page, so that the corresponding rendering engine can be queried according to the engine characteristic state in the running state. After the rendering engine is queried, the target computing power can be determined according to the different rendering engines and the target computing power can be dispatched to render the target page and its animation effect.

For different page types, different rendering engines are usually used. Different pages of the same application may belong to different page types, which may be rendered by different rendering engines, i.e., different page types correspond to different rendering engines, thereby requiring different computing power configurations to achieve the effect of lowering power consumption while maintaining display stability. For example, the page type of the Moments page of WeChat is HWUI, while the page type of the news page of the public number is HWUI+Webview. Therefore, even the same application needs to use different rendering engines to render pages of different page types. Compared to the approach of uniformly applying the same computing power to render different pages within the same application, the present disclosure identifies different page types and determines the corresponding target computing power needed to render each page and its animation effects. This enables adaptive computing power dispatching at the page level, which maintains stable display effects, such as keeping the frame rate consistent without frame drops, and prevents waste of computing power. For example, pages with lower power requirements can be rendered adaptively using less power, thereby reducing the overall power consumption of electronic devices.

In some embodiments, the animation rendering method further includes:

Step S80: Identifying the page type of the target page of the user-input event during the duration of the animation effect.

Step S90: Re-executing the step of determining the target computing power based on the page type and subsequent steps in response to the change of page type.

In other words, identifying the page type in real time and thereby dispatching the required target computing power to render the page in time when the page type changes. This can maintain the stability of the display effect, e.g., keeping the frame rate stable without dropping frames, etc., and prevents waste of computing power, e.g., for the pages with lower computing power requirement within the application program can adaptively dispatch lower computing power for rendering, thereby reducing the power consumption of electronic devices.

In some embodiments, before dispatching the target computing power to generate an animation effect corresponding to the user-input event on the target page, the animation rendering method further includes:

Step S50: Determining the duration of the animation effect.

Rendering a dynamic page generally requires more computing power than a static page. When an animation effect is generated on the target page in response to a user-input event, a higher computing power is usually required for rendering than before or after the animation effect is generated on the target page. If the high computing power is still maintained after the animation effect is finished, it will result in a waste of computing power and increase the power consumption of the electronic device. Therefore, in this embodiment, the duration of the animation effect can be determined before generating the animation effect on the target page, so that the duration of dispatching the target computing power for rendering the target page can be subsequently determined according to the duration of the animation effect. This can reduce the waste of computing power while maintaining the stability of the display effect, e.g., keeping the frame rate stable without dropping frames, etc., and prevents waste of computing power, e.g., for the pages with lower computing power requirement within the application program can adaptively dispatch lower computing power for rendering, thereby reducing the power consumption of electronic devices.

In some embodiments, dispatching the target computing power to generate an animation effect corresponding to a user-input event on a target page includes:

Step 61: Maintaining the target computing power for the duration of the animation effect to generate an animation effect on the target page corresponding to the user-input event.

In this embodiment, the duration of the animation effect is determined before generating the animation effect on the target page, thereby the duration for dispatching the target computing power is determined to render the target page based on the duration of the animation effect, and the target computing power for rendering the target page is maintained during the duration of the animation effect. This can maintain the stability of the display effect, e.g., keeping the frame rate stable without dropping frames, etc., and prevents waste of computing power, e.g., for the pages with lower computing power requirement within the application program can adaptively dispatch lower computing power for rendering, thereby reducing the power consumption of electronic devices.

In some embodiments, determining the duration of the animation effect includes:

Step 51: Determining the user-gesture operation corresponding to the user-input event.

Step 52: Obtaining the dynamic parameters of the target page corresponding to the user-gesture operation.

Step 53: Calculating the duration of the animation effect based on the dynamic parameters of the target page.

The user-gesture operation includes swiping, two-finger pinching, two-finger separating, etc. For example, the user swipes on the screen using a finger or a stylus to trigger a scrolling instruction, a rotation instruction, a zooming instruction, etc. Alternatively, the user pinches using two fingers to trigger a zooming instruction with respect to the display content, etc. The present disclosure does not impose any limitations on the user-gesture operation.

The page dynamic parameters corresponding to the user-gesture operation include page scrolling speed, page scrolling acceleration, etc. The page dynamic parameters are used to calculate the duration of the page animation effect. The page dynamic parameters can be different for different user gestures.

Exemplarily, for the swiping instruction that is triggered by the user, a corresponding page dynamic parameter, such as page scrolling speed, page scrolling acceleration, etc., can be determined based on swiping distance, swiping speed, etc. The duration of the animation effect then can be calculated based on the page scrolling speed and the page scrolling acceleration.

In this embodiment, the duration of the animation effect is determined based on the user-gesture operation, and the duration of the target computing power is then determined, so that the target computing power can be adaptively dispatched according to the user-gesture operation. For example, when the duration of the swipe is short, the duration of the target computing power is shortened accordingly, and when the duration of the swipe is long, the duration of the target computing power is lengthened accordingly. This can maintain the stability of the display effect, e.g., keeping the frame rate stable without dropping frames, etc., and prevents waste of computing power, e.g., for the pages with lower computing power requirement within the application program can adaptively dispatch lower computing power for rendering, thereby reducing the power consumption of electronic devices.

It is understood by those skilled in the art that in specific embodiments of the above method, the order in which the steps are written does not imply any limitation of the implementation process by implying a strict order of execution, and that the specific order in which the steps are to be executed should be determined in terms of their functionality and possible internal logic.

Referring to FIG. 2, FIG. 2 is a schematic diagram of an interactive process within an animation rendering system of an embodiment of the present disclosure. The animation rendering system is configured to implement the animation rendering method in any of the above embodiments. In some embodiments, the animation rendering system of the present disclosure includes a swiping strategy module and a resource dispatching module. The third-party application generates user-input event when the user operates the electronic device. For example, when the user swipes on the cell phone in order to browse the Moments page, WeChat generates corresponding swipe events. The third-party application sends the user-input event to the swiping strategy module, and after the swiping strategy module obtains the user-input event, the swiping strategy module queries the resource dispatching module for the running status of the target process, which is the process used to provide the target page of the user-input event, e.g., if the target page of the user's swiping instruction is the Moments page, then the target process that processes the swiping instruction is the process used for rendering the content of the Moments page and its scrolling animation. The resource dispatching module is configured to record and analyze the running state of the target process and return the running state of the target process to the swiping strategy module. The running state of the target process includes the engine characteristic state of the rendering engine that renders the target page, so that the swiping strategy module can query the corresponding rendering engine according to the engine characteristic state in the running state. Generally different rendering engines correspond to different page types, so that the page type can be determined after querying the rendering engine, and the target computing power can be determined and dispatched to render the target page and its animation effect according to different rendering engines or page types.

In the above-described embodiment, according to the page type of the target page on which the user-input event occurs, a corresponding target computing power is determined and dispatched to generate the animation effect corresponding to the user-input event on the target page. Since the dispatched target computing power corresponds to the page type, different target computing power can be dispatched for different page types, allowing adaptation to the different page types through corresponding computing power allocation. Therefore, this enables to maintain the stability of the display effect, and not result in the waste of computing power, thereby reducing the power consumption of the electronic device.

In some embodiments, the swiping strategy module is further configured to determine the target process for processing the user-input event, and to identify the page type of the target page for the user-input event based on the running state of the target process.

In some embodiments, the running state includes the engine characteristic state of the rendering engine. The swiping strategy module is further configured to determine, based on the engine characteristic state, the rendering engine of the target page, and based on the rendering engine, to identify the page type of the target page.

In some embodiments, the swiping strategy module is further configured to determine the duration of the animation effect.

In some embodiments, the resource dispatching module is further configured to maintain the target computing power for the duration of the animation effect to generate the animation effect corresponding to the user-input event on the target page.

In some embodiments, the swiping strategy module is further configured to determine the user-gesture operation corresponding to the user-input event, to obtain the page dynamic parameters corresponding to the user-gesture operation, and to calculate the duration of the animation effect based on the page dynamic parameters.

In some embodiments, the animation rendering system is further configured to identify, during the continuation of the animation effect, the page type of the target page for the user-input event, and in response to the change of page type, to re-execute the step of determining the target computing power based on the page type and thereafter.

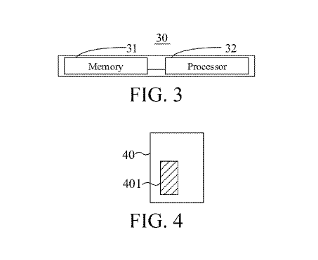

Referring to FIG. 3, FIG. 3 is a schematic diagram of a module of an electronic device 30 of an embodiment of the present disclosure. The electronic device 30 includes a memory 31 and a processor 32. The memory 31 and the processor 32 are mutually coupled to each other. The processor 32 is configured to execute program instructions stored in the memory 31 to implement the steps in any of the above embodiments of the animation rendering method. In a specific embodiment scenario, the electronic device 30 may include a microcomputer, a server, but is not limited thereto. In addition, the electronic device 30 may include a mobile device such as a laptop, a tablet computer, and the like, but is not limited thereto.

Specifically, the processor 32 is configured to control itself as well as the memory 31 to implement the steps in any of the above embodiments of the animation rendering method. The processor 32 may also be referred to as a CPU (Central Processing Unit). The processor 32 may be an integrated circuit chip with signal processing capabilities. The processor 32 may also be a general-purpose processor, a Digital Signal Processor (DSP), an Application Specific Integrated Circuit (ASIC), a Field-Programmable Gate Array (FPGA), or other programmable logic devices, discrete gate or transistor logic device, or discrete hardware component. The general-purpose processor may be a microprocessor or the processor may also be any conventional processor, etc. Alternatively, the processor 32 may be co-implemented by the integrated circuit chip.

In the above-described embodiment, according to the page type of the target page on which the user-input event occurs, the corresponding target computing power is determined and dispatched to generate the animation effect corresponding to the user-input event on the target page. Since the dispatched target computing power corresponds to the page type, different target computing power can be dispatched for different page types, allowing adaptation to the different page types through corresponding computing power allocation. Therefore, this enables to maintain the stability of the display effect, and not result in the waste of computing power, thereby reducing the power consumption of the electronic device.

Referring to FIG. 4, FIG. 4 is a schematic diagram of a module of a computer-readable storage medium 40 of an embodiment of the present disclosure. The computer-readable storage medium 40 stores program instructions 401 capable of being run by the processor 32, and the program instructions 401 are used to implement the steps in any of the above embodiments of the animation rendering method.

In the above-described embodiment, according to the page type of the target page on which the user-input event occurs, the corresponding target computing power is determined and dispatched to generate the animation effect corresponding to the user-input event on the target page. Since the dispatched target computing power corresponds to the page type, different target computing power can be dispatched for different page types, allowing adaptation to the different page types through corresponding computing power allocation. Therefore, this enables to maintain the stability of the display effect, and not result in the waste of computing power, thereby reducing the power consumption of the electronic device.

In some embodiments, the devices provided by embodiments of the present disclosure have functions or contain modules that can be used to perform the methods described in the method embodiments above, the specific embodiments of which can be described with reference to the description of the method embodiments above, and will not be repeated herein for the sake of brevity.

The foregoing description of the various embodiments tends to emphasize the differences between the various embodiments, the similarities or likenesses of which can be cross-referenced and will not be repeated herein for the sake of brevity.

In the several embodiments provided in this disclosure, it should be understood that the methods and devices disclosed can be realized in other ways. For example, the above-described embodiments of the device are merely schematic, e.g., the division of modules or components is merely a logical functional division. The actual implementation may be divided in other ways, e.g., units or components may be combined or may be integrated into another system, or some features may be ignored, or not implemented. Another point is that the mutual coupling or direct coupling or communication connection shown or discussed may be indirect coupling or communication connection through some interface, device or unit, which may be electrical, mechanical or otherwise.

In addition, each functional unit in various embodiments of the present disclosure may be integrated in a processing unit, or each unit may physically exist separately, or two or more units may be integrated in a single unit. The above integrated units may be realized either in the form of hardware or in the form of software functional units.

The integrated units may be stored in a computer-readable storage medium when implemented as software functional units and sold or used as a stand-alone product. Based on this understanding, the technical solution of the present disclosure may be embodied, in essence or as a contribution to the prior art, or in whole or in part, in the form of a software product, which is a computer software product stored in a storage medium including a number of instructions for causing a computer device (which may be a personal computer, a server, or a network device, etc.) or a processor to perform all or part of the methods of the various embodiments of the present disclosure. The aforementioned storage media include USB, removable hard disks, read-only memories (ROM), random access memories (RAM), magnetic disks, or CD-ROMs, and other media that can store program code.

If the technical solution of the present disclosure involves the processing of personal information, the product implementing the technical solution shall inform the individual of the rules for handling such information and obtain their explicit and independent consent prior to processing. If the technical solution of the present disclosure involves sensitive personal information, the product implementing the technical solution shall obtain the individual’s separate consent prior to processing such information, and shall also comply with the requirement of express consent. For example, at a personal information collection device such as a camera, a clear and conspicuous sign is set up to inform that it has entered the scope of personal information collection and that personal information will be collected, and if an individual voluntarily enters the scope of collection, it is deemed that he/she has agreed to the collection of his/her personal information. Alternatively, in the case of a device that processes personal information, a pop-up message is set up to inform individuals of the rules of personal information processing using a conspicuous sign/message or to invite individuals to upload their personal information on their own. Wherein the rules for handling personal information may include such information as the person who handles the personal information, the purpose of handling the personal information, the manner of handling, and the type of personal information handled.

What is claimed is:

1. A method of animation rendering, comprising:
obtaining a user-input event, and recognizing a type of a target page that generated the user-input event to obtain a page type;
determining target computing power based on the page type; and
dispatching the target computing power to generate an animation effect on the target page corresponding to the user-input event.

2. The method for animation rendering as claimed in claim 1, wherein the step of obtaining the user-input event, and recognizing the type of the target page that generated the user-input event to obtain the page type comprises:
determining a target process for processing the user-input event; and
identifying the page type of the target page for the user-input event based on a running state of the target process.

3. The method for animation rendering as claimed in claim 2, wherein:
the running state comprises an engine characteristic state of a rendering engine; and
the step of identifying the page type of the target page for the user-input event based on the running state of the target process comprises:
determining the rendering engine of the target page based on the engine characteristic state; and
identifying the page type of the target page based on the rendering engine.

4. The method for animation rendering as claimed in claim 3, wherein different page types correspond to different rendering engines.

5. The method for animation rendering as claimed in claim 1, further comprising:
determining a duration of the animation effect before the step of dispatching the target computing power to generate the animation effect on the target page corresponding to the user-input event;
wherein the step of dispatching the target computing power to generate the animation effect on the target page corresponding to the user-input event comprises:
maintaining the target computing power for the duration of the animation effect to generate the animation effect on the target page corresponding to the user-input event.

6. The method for animation rendering as claimed in claim 5, wherein the step of determining the duration of the animation effect comprises:
determining a user-gesture operation corresponding to the user-input event;
obtaining dynamic parameters of the target page corresponding to the user-gesture operation; and
calculating the duration of the animation effect based on the dynamic parameters of the target page.

7. The method for animation rendering as claimed in claim 1, further comprising:
identifying the page type of the target page of the user-input event during the duration of the animation effect; and
re-executing the step of determining the target computing power based on the page type and subsequent steps in response to a change of the page type.

8. The method for animation rendering as claimed in claim 1, wherein the user-input event comprises a user’s swiping operation on the target page.

9. An electronic device, comprising:
a memory; and
a processor, coupled to the memory, wherein the processor is configured to execute program instructions stored in the memory to carry out the method of the animation rendering as claimed in claim 1.

10. A computer-readable storage medium, having program instructions stored thereon, wherein the computer-readable storage medium is configured to carry out the method of the animation rendering as claimed in claim 1 when the program instructions are run by a processor.
